(19) United States
(12) Patent Application Publication
(10) Pub. No.: US 2002/0057810 A1
(43) Pub. Date: May 16, 2002

(54) Computer and voice communication unit with handsfree device

(76) Inventor: Peter V. Boesen, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/042,863

(22) Filed: Jan. 9, 2002

Related U.S. Application Data
(63) Continuation-in-part of application No. 09/587,743, filed on Jun. 5, 2000.
Application No. 09/587,743 is a continuation-in-part of application No. 09/309,107, filed on May 10, 1999.
(63) Continuation-in-part of application No. 09/607,305, filed on Jun. 30, 2000.

(51) Int. Cl. H04B 1/38; H04R 25/00

(52) U.S. Cl. 381/151; 381/312; 455/90; 381/376

(57) ABSTRACT

A system for voice communications is disclosed. The system includes a computer having a housing, a short-range transceiver operatively connected to the computer, a voice transceiver operatively connected to the computer, a handsfree voice communications unit in communication with the short-range transceiver, the computer adapted to receive voice sound information from the short-range transceiver, the computer adapted to receive voice sound information from the voice transceiver, the computer adapted to send voice sound information to the short-range transceiver, and the computer adapted to send voice sound information to the voice transceiver. The present invention also includes methods for voice communication. These include transceiving voice sound information between a handsfree voice communication unit and a computer over a short-range of first communications channel and transceiving voice sound information between a computer and a remote location over a second communications channel.

### CROSS-REFERENCE TO RELATED APPLICATIONS

This application is a continuation-in-part of U.S. patent application Ser. No. 09/587,743 filed on Jun. 5, 2000, which is a continuation of U.S. patent application Ser. No. 09/309,107 which is now U.S. Pat. No. 6,094,492; and this application is also a continuation-in-part of U.S. patent application Ser. No. 09/607,305 filed on Jun. 30, 2000.

### BACKGROUND OF THE INVENTION

1. Field of the Invention

The present invention relates to a communication system including a computer and voice communication unit with a handsfree device. The present invention relates to, but is not limited to, smart phones, notebook computers, PDAs and field infantry communication devices, among others.

2. Problems in the Art

People today find themselves with the need for numerous electronic devices that fill various roles such as voice communications, electronic communications, computer functions, and other uses. Recently there have been attempts at converging some of these functions and some of these devices in order to improve the convenience to an operator, reduce costs, and improve overall functionality of these devices. Unfortunately, many attempts to converge technologies have failed. Attempts to do so have generally resulted in electronic devices that are too expensive, too bulky and unwieldy. Devices that are combinations of other devices also tend to be reduced or limited in functionality. These devices may have multiple functions but are not reputed to perform the functions to a user's satisfaction.

Specifically, devices which have attempted to incorporate voice communication or functionality have been inadequate. Whether voice is used for voice communications, voice activation, or voice recognition, the quality of the voice information is of great importance. Today's handsfree units are often inadequate in this respect because of the quality of the microphone or the speaker, the limitation in size of the microphone or speaker and the placement of the microphone or speaker. This limitation in voice quality has been one problem that has made the use of a handsfree voice communications unit with other devices problematic or unrealizable.

Devices that combine the functions of voice communication with that of computers have also been deficient. In particular, prior art attempts have resulted in devices with substantial disadvantages. For example, prior art attempts of simply combining telephones with computers have resulted in devices that do not work as well as having a separate computer and a separate telephone. Some of these attempts have resulted in devices that include bulky handsets or occlusive earpieces. More recent attempts have focused on combining computers in the form of PDAs or similar devices into cellular telephones. This results in cellular telephones that are bigger, bulkier, and more burdensome than cellular telephone without the additional functionality. Therefore, the many attempts at combining or converging technologies have not provided synergistic results.

Thus, there are a number of needs not currently being addressed related to handsfree voice communication and computers.

Therefore, it is a primary object, feature, or advantage of the present invention to provide a system that improves upon the state of the art.

It is another object, feature, or advantage of the present invention to provide a handsfree voice communication system capable of improved voice quality.

It is a further object, feature, or advantage of the present invention to provide a system for voice communications over a channel such as a cellular phone channel that is convenient and easy to use.

It is a further object, feature, or advantage of the present invention to provide a system that combines a computer with voice communications in a manner that retains the advantages of a computer.

It is a further object, feature, or advantage of the present invention to provide for voice communications without requiring a large and unwieldy handset or headset.

A still further object, feature, or advantage of the present invention is to provide a voice communication unit that provides for secure access to computers.

Yet another object of the present invention is to provide a system having a computer and voice communication unit with a handsfree device in a manner that provides synergistic results. These and other objects, features, or advantages will become apparent from the disclosure that follows.

### BRIEF SUMMARY OF THE INVENTION

The present invention is a system that provides for improved voice communications and computer functionality. The system includes a computer, a short-range transceiver operatively connected to the computer, a voice transceiver operatively connected to the computer, and a handsfree voice communications unit in communication with the short-range transceiver. The computer is adapted to receive voice sound information from the short-range transceiver, the computer is adapted to receive voice sound information from the voice transceiver, the computer is adapted to send voice sound information to the short-range transceiver, and the computer is adapted to send voice sound information to the voice transceiver.

This system provides a number of advantages. The handsfree voice communication unit can be an earpiece or headset. Because it may be in wireless communication with the short-range transceiver connected to the computer, the operator need not hold a bulky device such as a cellular phone. Further, because this system includes a computer that may be a notebook computer or desktop computer, or other computer, the functionality of the computer aspect of the system is not compromised such as in smart phones or similar devices which attempt to provide both computer and phone functionality. No handheld unit or handset is required such as is required in smart phones because the computer provides for improved voice processing and/or voice recognition.

In a preferred embodiment, the handsfree voice communications unit includes a bone conduction sensor that can be further used to improve the overall voice quality. In addition, the computer can transduce voice sound information with a built-in microphone instead of, or in addition to, an air conduction sensor within the handsfree voice communications unit, or a combination thereof.

In this manner an improved system is realized that is both convenient and functional.

### BRIEF DESCRIPTION OF THE DRAWINGS

The present invention is illustrated by way of example and not limitation in the figures of the accompanying drawings, and reference numerals indicate similar elements and in which:

FIG. 1A is a block diagram of a system according to the present invention.

FIG. 1B is a block diagram of the handsfree voice communications unit according to one embodiment of the present invention.

FIG. 2A is a pictorial representation of a system according to the present invention wherein the short-range transceiver and voice transceiver of the computer are removable.

FIG. 2B is a diagram of the present invention wherein the short-range transceiver is removable and connectable to an external voice transceiver.

FIG. 2C is a diagram of the present invention wherein the short-range transceiver is removable.

FIG. 3 is a pictorial representation of one embodiment according to the present invention where the short-range transceiver and voice transceiver are built into a computer.

FIG. 4 is a diagram of the methodology of one embodiment according to the present invention.

FIG. 5 is a diagram showing security aspects according to the present invention.

### DETAILED DESCRIPTION OF THE INVENTION

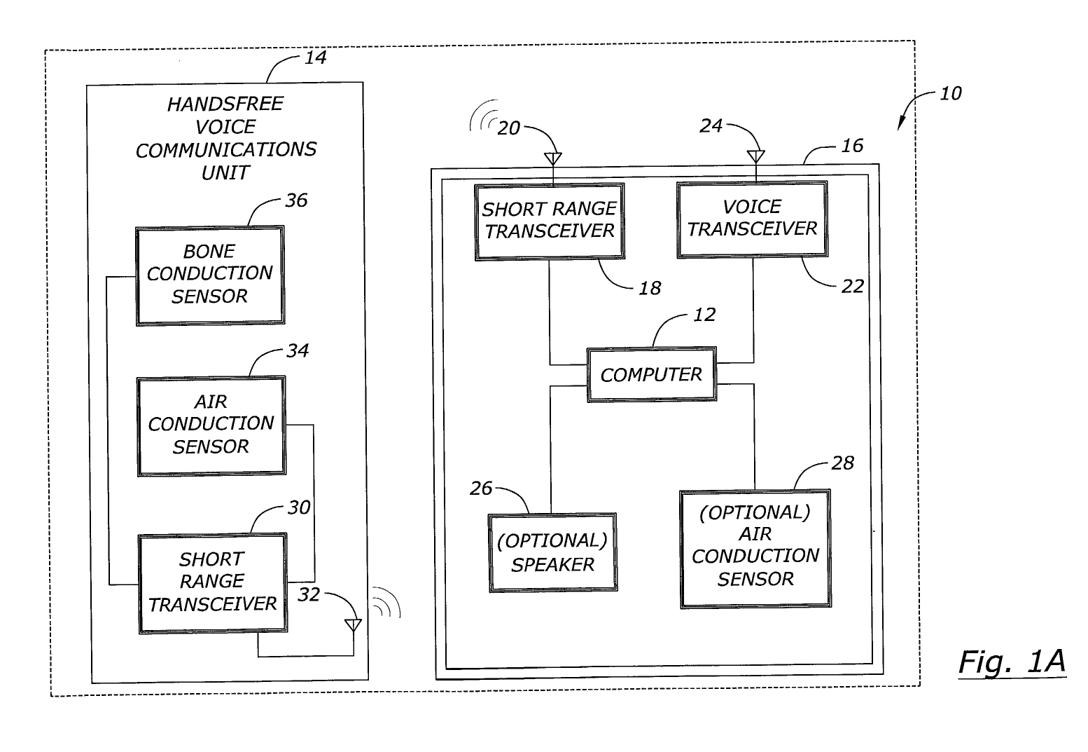

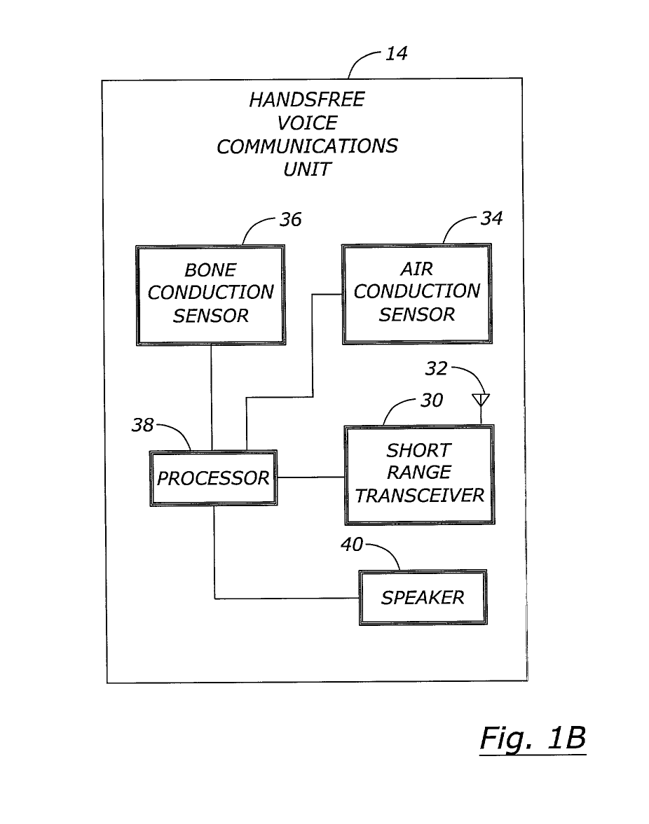

FIG. 1A shows the system 10 of the present invention. The system includes a computer 12 and a handsfree voice communications unit 14. The computer 12 is contained within a housing 16. The computer 12 is electrically connected to a short-range transceiver 18. The short-range transceiver 18 may have an antenna 20. The computer is also connected to a voice transceiver 22 which may have an antenna 24. The antenna 24 may be either internal or external to the voice transceiver 22. The voice transceiver 22 is adapted to work with at least one of any number of communications networks, including radio communications networks, cellular networks, satellite networks, and others. In addition, the computer 12 is optionally connected to a speaker 26 and an air conduction sensor 28 such as a microphone. The short-range transceiver 18 of the computer 12 is in communication with the handsfree voice communications unit 14. The handsfree voice communications unit 14 includes a short-range transceiver 30 with an antenna 32. The short-range transceiver 30 communicates with the computer's short-range transceiver 18. In addition, the handsfree communications unit 14 includes an optional bone conduction sensor 36 and optional air conduction sensor 34. Although not shown in FIG. 1A, the handsfree voice communications unit 14 may also include a processor.

FIG. 1B shows one embodiment of the handsfree voice communications unit 14 with a processor 38. The air conduction sensor 34 and/or the bone conduction sensor 36 send signals received by the processor 38 so that processing may be performed prior to transmission of the signals from the short-range transceiver 30. In addition, the handsfree voice communications unit 14 may include a speaker 40 that is electrically connected to the short-range transceiver 30 or the processor 38. This allows signals received from the short-range transceiver 30 to be transduced into a sound signal to be heard by the operator of the handsfree voice communications unit 14. Although a processor 38 is shown in this preferred embodiment, a processor 38 need not be present. In addition, the present invention contemplates that either a bone conduction sensor or an air conduction sensor may be used, and does not require both. Furthermore, the present invention allows for multiple air conduction sensors and/or multiple bone conduction sensors to be used.

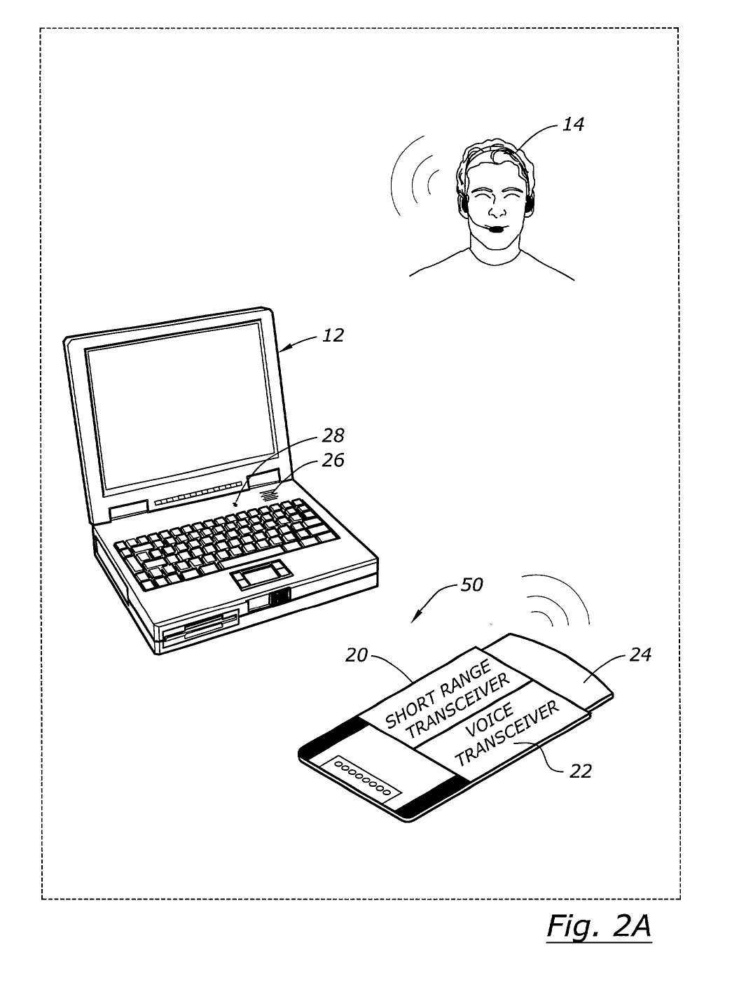

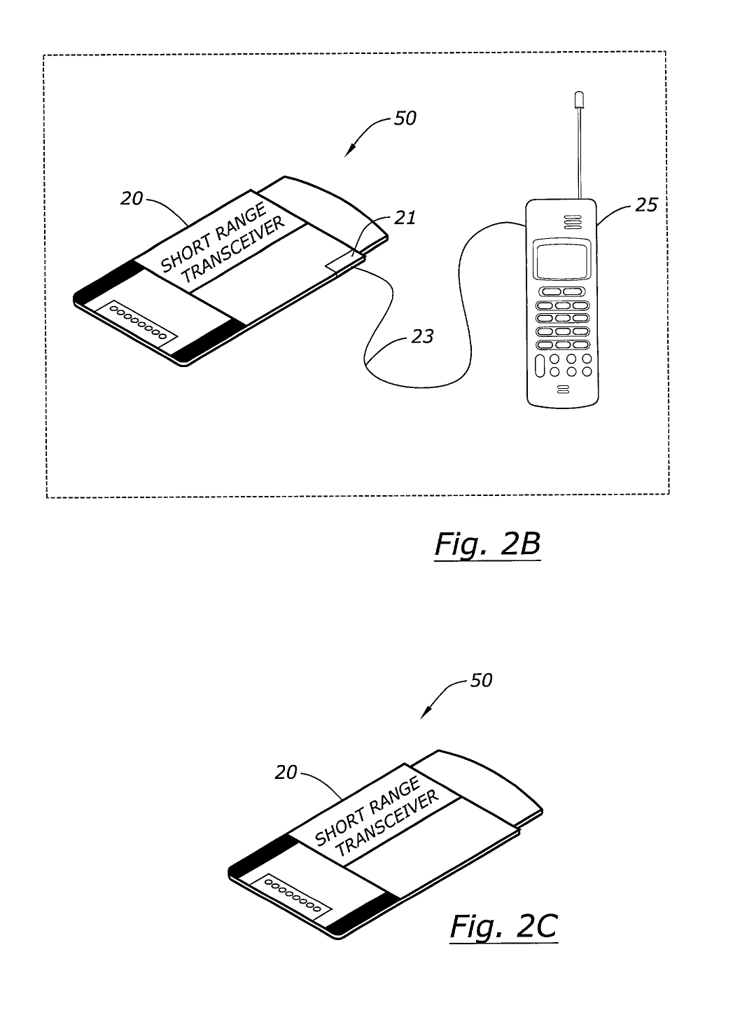

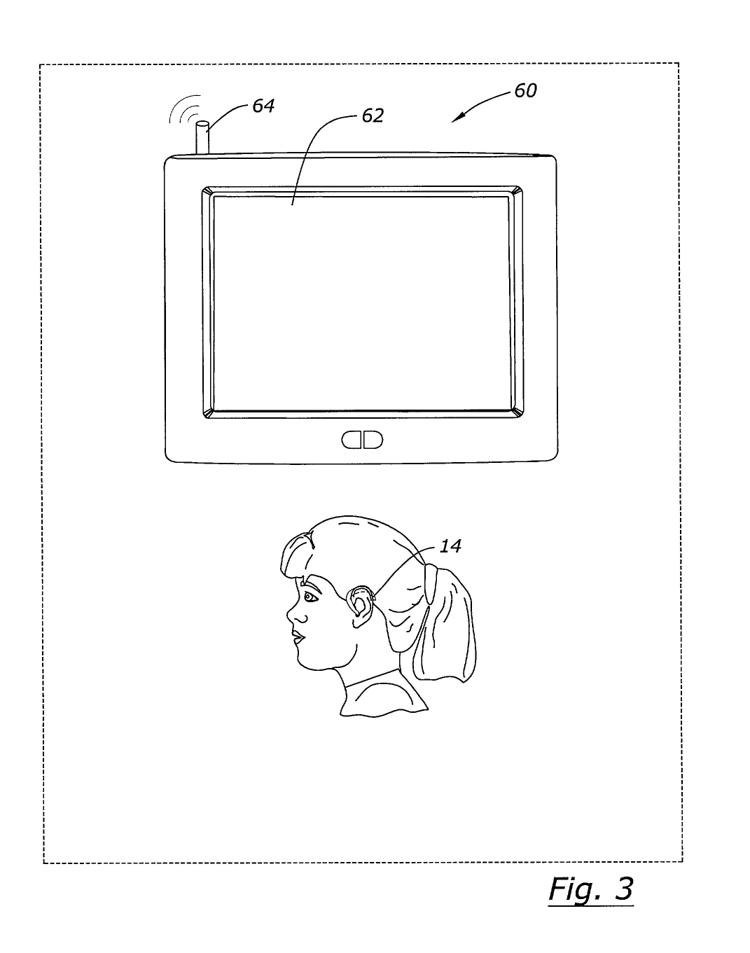

FIG. 2A shows a pictorial representation of one embodiment of the present invention. In FIG. 2A, the computer 12 is a notebook computer. Although a notebook computer is shown, the present invention contemplates that other sizes and types of computers may be used, including, but not limited to desktop computers. The computer 12 includes a speaker 26 and a microphone input 28. One embodiment of the handsfree voice communications unit 14 sends a signal to the computer 12. The module or card 50, which is removable, allows any computer capable of accepting the module to be given the functionality of the short-range transceiver and the voice transceiver. The short-range transceiver 20 and the voice transceiver 22 are located on the removable module 50. This removable module 50 allows any computer capable of accepting the module to be given the functionality of the short-range transceiver and the voice transceiver.

The present invention contemplates that instead of a card bus module, other types of modules may be used with other types of interfaces. Further, this functionality can be built into the computer 12 as well.

As shown in FIG. 2B, the present invention also contemplates that the removable module 50 need not contain the voice transceiver. Instead, the removable module 50 can include a port or connector 21 for connecting a removable module to an external voice transceiver 25 such as a cellular telephone. As shown in FIG. 2C, the present invention also contemplates that the removable module 50 need not include a voice transceiver. The removable module of FIG. 2C can rely upon voice transceiver operations being performed by the computer or other external devices connected to the computer. For example, the present invention contemplates that the computer can perform voice over IP functions, be otherwise connected to a cellular telephone, other radio transceiver, or other voice transceiver devices.

FIG. 3 shows a pictorial representation of another embodiment of the present invention in which the functionality of the removable module 50 of FIG. 2A is built into the computer 60. The computer 60 is shown as a pen computer with a display 62 but can be any type of desktop, notebook, handheld, or other computer. The handsfree voice communications unit 14 sends signals to the computer 60. The signals are received through an antenna 64 that also may be built into the computer either internally, or protruding as shown in the embodiment of FIG. 3.

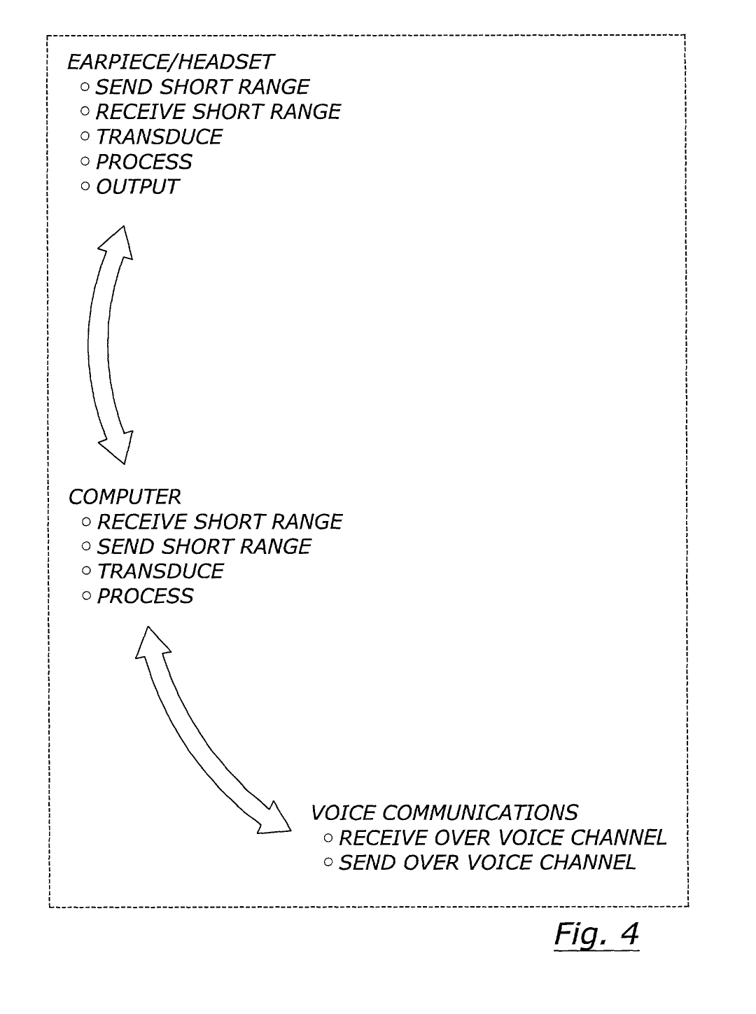

FIG. 4 is a diagram showing the methodology of the present invention. According to FIG. 3, the earpiece or headset of the handsfree voice communications unit may send and receive short-range signals, and may transduce voice sound signals through use of a bone conduction sensor and/or an air conduction sensor and optionally it may process the transduced signals prior to sending. Also, it may process the received signals prior to outputting a signal to its speaker.

The computer 60 can receive the short-range signals as well as send the short-range signals. In addition, the computer can independently transduce air conduction signals with a built-in microphone. The computer can also provide additional processing. This processing can include sound processing to improve the quality of the signal, conditioning the signal, or otherwise processing as may be useful or desirable. In addition, the computer may process the signal for voice activation or voice transmission purposes. The computer also includes a voice communications unit or voice transceiver over which the computer can receive information over a voice channel or send information over a voice channel. This voice communications channel can be any one of a number of channels such as may be associated with cellular telephones, satellite telephones, radio telephones, voice over IP, or other voice communications channels. The present invention is in no way limited to these particular types of voice communication channels.

In this manner, the present invention provides a number of advantages. In particular, an operator can simply wear the earpiece or headset for voice communication purposes without needing to hold a handset or be tethered to one. In addition, the operator has the advantages of the full functionality of a computer and is not limited to the reduced functionality associated with a smartphone or other device. Because the computer is used, improved voice quality can be obtained as increased speech processing functionality can be performed as limitations of size and power consumption requirements are reduced or effectively eliminated. In addition, improved voice recognition and voice activation functions may also be facilitated.

Another advantage of use of the computer is that a microphone of the computer can also be used as another processing point. The microphone signal can be used to improve the sound of transduced voice sound information. For example, the microphone signal may be used as a basis for determining ambient noise, ambient noise can be filtered from that received from the air conduction sensor in the handsfree voice communication unit 14. An additional processing point can also be used to determine the direction from which sound is emanating, which can further be used for sound processing, determining the distance of a sound source or other types of processing. These are merely several examples contemplated by the present invention, others methodologies may be appropriate given a particular context, configuration, or desired result. The design of the present invention provides the flexibility to implement this or other methodologies.

Where the invention provides for short-range communications, additional advantages are gained. In particular, a number of security features can be realized to one skilled in the art who has the benefit of this disclosure. For example, a handsfree voice communications unit 14 can be used to seamlessly provide secured access to a computer. Referring to FIG. 1A, the handsfree voice communications unit 14 can be used to identify or verify any particular person. This identification process can take one of numerous forms. For example, the person can be identified based on voice pattern recognition. Until a person has been identified, the person would not be able to access the computer or its accompanying voice transceiver. Alternatively, the person would be able to access the computer and/or the voice transceiver, but their access would be limited in scope. Either method of identification can take one of several forms. For example, a person can be identified based on their voice pattern. As the voice communications unit 14 is already transmitting voice sound information, the computer unit 16 can receive this information, compare the received voice pattern against the known voice pattern and grant or restrict access based on the degree of similarity between the two voice patterns. A handsfree communication unit can also transmit a unique identifier that is received by the computer unit 10.

Where a unique identifier is used, another security feature is the tracking of each handsfree voice communication unit 14. As the handsfree voice communications unit 14 and its short-range transceiver 30 enter into or leave the reception range of the voice transceiver 22 of the computer unit 10, the computer unit 10 can track whether the voice communications unit 14 is inside or outside of that range. A plurality of voice communication units 10 can be used to track one or more handsfree voice communications unit. As each handsfree voice communication unit 14 enters or exits the range of each voice transceiver 22 range, the location or position associated with the handsfree voice communications unit 14 can change.

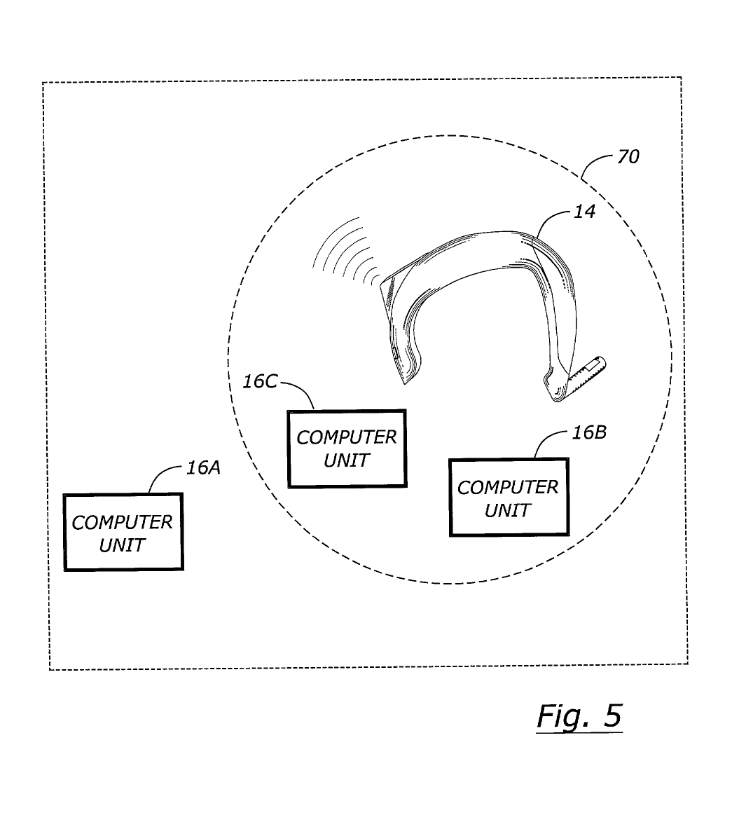

This is best shown in FIG. 5 where a handsfree voice communications unit 14 transmits a signal within a transmission range designated by reference numeral 70. One or more computer units 16 can be within range. As shown in FIG. 5, computer units 16B and 16C are within range of voice communications unit 14 while computer unit 16A is outside that range. Handsfree voice communication unit 14 transmits voice information or another identifier—such as an IP address or a unique identifier to each of the computer units 16B and 16C. These computer units can then grant or deny access based on the identification of handsfree voice communications unit 14.

Because a fully functional computer may be used, a number of other advantages are realized. For example, voice sound information, including complete conversations, may be stored digitally on the computer and/or transcribed by the computer. Further, voice sound signals received by the computer can be processed. This processing provides for the elimination or reduction of static or other ambient noise, or other processing capable of improving voice signal quality.

Therefore, an improved system comprising a computer and a handsfree communication device has been disclosed. The present invention includes numerous variations regarding the types of processing used; whether the voice communication functionality is built-in to the computer or whether it is connected to the computer through use of a removable device, cable, or other interface. These and numerous other variations such as may be logically apparent to one skilled in the art from that which is disclosed are within the spirit and scope of the invention.

What is claimed is:

1. A system comprising:
a computer having a housing;
a short-range transceiver operatively connected to the computer;
a handsfree voice communications device unit in communication with the short-range transceiver;
the computer adapted to receive voice sound information from the short-range transceiver; and
the computer adapted to send voice sound information to the short-range transceiver.

2. The system of claim 1 wherein the handsfree voice communications unit is a headset.

3. The system of claim 1 wherein the handsfree voice communications unit is an earpiece.

4. The system of claim 1 wherein the handsfree voice communication unit includes a bone conduction sensor.

5. The system of claim 1 wherein the handsfree voice communication unit includes an air conduction sensor.

6. The system of claim 1 wherein the handsfree voice communication unit includes both an air conduction sensor and a bone conduction sensor.

7. The system of claim 3 wherein the earpiece is smaller in size than an interior of an external auditory canal of a user whereby the earpiece does not block the external auditory canal.

8. The system of claim 3 wherein the earpiece includes a bone conduction sensor.

9. The system of claim 3 wherein the handsfree voice communications unit includes an air conduction sensor and a bone conduction sensor.

10. The system of claim 3 wherein the handsfree voice communications unit includes an air conduction sensor.

11. The system of claim 1 wherein the short-range transceiver is disposed within the housing of the computer.

12. The system of claim 10 further comprising an antenna electrically connected to the short-range transceiver at least partially extending beyond the housing.

13. The system of claim 1 further comprising a voice transceiver operatively connected to the computer, the computer adapted to receive voice sound information from the voice transceiver and the computer adapted to send voice sound information to the voice transceiver.

14. The system of claim 13 wherein the voice transceiver is disposed within the housing of the computer.

15. The system of claim 13 further comprising an antenna electrically connected to the voice transceiver at least partially extending beyond the housing.

16. The system of claim 13 wherein the short-range transceiver and the voice transceiver are disposed within the housing.

17. The system of claim 13 wherein the voice transceiver is contained within a removable telephone transceiver module.

18. The system of claim 17 wherein the removable module is housed within a PC card.

19. The system of claim 1 wherein the short-range transceiver is a removable short-range transceiver module.

20. The system of claim 19 wherein the short-range transceiver module is housed within a PC card.

21. The system of claim 13 wherein the voice transceiver and the short-range transceiver are housed within a removable module.

22. The system of claim 21 wherein the removable module is a PC card.

23. The system of claim 13 wherein the short-range transceiver is housed within a removable module and a voice transceiver is electrically connected to the removable module.

24. The system of claim 1 wherein the handsfree voice communications unit includes a short-range transceiver.

25. A method of voice communication comprising:
transceiving voice sound information between a handsfree voice communication unit and a computer over a short-range first communications channel;
transceiving voice sound information between the computer and a remote location over a second communications channel.

26. The method of claim 25 further comprising processing voice sound information.

27. The method of claim 25 further comprising transducing voice sound information at the handsfree voice communication unit.

28. The method of claim 26 wherein the step of transducing includes transducing a bone conduction signal.

29. The method of claim 25 further comprising identifying the handsfree voice communication unit.

30. The method of claim 25 further comprising comparing the voice sound information to voice sound information from a known source for security purposes.

31. A method of voice communication comprising:
transducing a bone conduction signal at an earpiece;
sending the bone conduction signal to a computer;
creating a voice sound signal at least partially based on the bone conduction signal at the computer;
transmitting the voice sound signal over a voice communications channel.

32. The method of claim 31 further comprising transducing an air conduction signal and wherein the voice sound signal is at least partially based on the air conduction signal.

33. The method of claim 32 wherein the air conduction signal is transduced at an earpiece.

34. The method of claim 32 wherein the air conduction signal is transduced at the computer.

35. The method of claim 33 further comprising transducing a second air conduction signal at the computer wherein the voice sound signal is at least partially based on the second air conduction signal.

36. The system of claim 1 wherein the voice transceiver is adapted for cellular communications.

37. The system of claim 1 wherein the voice transceiver is adapted for satellite communications.

38. A removable card for voice communications over multiple channels comprising:
a body adapted to be removeably inserted into a slot;
a short-range transceiver disposed within the body and adapted for two-way voice communications.

39. The removable card of claim 38 further comprising a cardbus connector attached to the body for interfacing the card to a computer.

40. The removable card of claim 38 further comprising a voice transceiver disposed within the body and adapted for communications over a voice communication network.

41. The removable card of claim 38 further comprising a port for electrically connecting an external voice transceiver to the removable card.

42. A communications system comprising:
a computer;
a short-range transceiver operatively connected to the computer;
a voice transceiver operatively connected to the computer; and
a handsfree voice communications device having an air conduction sensor and a bone conduction sensor in communication with the short-range transceiver.

43. A method of providing secure access to a computer comprising:
receiving an identifier from a handsfree voice communication unit at the computer over a short-range first communications channel;
granting access based on the identifier;
transceiving voice sound information between the handsfree voice communication unit and the computer over the short-range first communications channel; and
transceiving voice sound information between the computer and a remote location over a second communications channel.

44. The method of claim 43 wherein the identifier is a voice sample.

45. The method of claim 43 wherein the identifier is an identifier associated with the handsfree voice communications channel.

46. The method of claim 45 wherein the identifier is a unique identifier.

47. The method of claim 45 wherein the identifier is an IP address.

48. The method of claim 43 further comprising the step of associating a first spatial position with the computer.

49. The method of claim 48 further comprising the step of associating a second spatial position of the voice communications unit based on the first spatial position associated with the computer.

50. A system comprising:
a computer having a housing;
a short-range transceiver operatively connected to the computer;
a voice transceiver operatively connected to the computer;
a handsfree voice communications device unit in communication with the short-range transceiver;
the computer adapted to receive voice sound information from the short-range transceiver;
the computer adapted to receive voice sound information from the voice transceiver;
the computer adapted to send voice sound information to the short-range transceiver; and
the computer adapted to send voice sound information to the voice transceiver.
